(19) United States
(12) Patent Application Publication
(10) Pub. No.: US 2014/0125635 A1
(43) Pub. Date: May 8, 2014

(54) ELECTRONIC PEN, AND ELECTRONIC PEN DATA INPUT SYSTEM AND METHOD USING THE SAME

(71) Applicant: SAMSUNG ELECTRO-MECHANICS CO., LTD., Suwon (KR)

(72) Inventors: Yong Il KWON, Gyunggi-do (KR); Tah Joon PARK, Gyunggi-do (KR); Kang Joo KIM, Gyunggi-do (KR)

(73) Assignee: SAMSUNG ELECTRO-MECHANICS CO., LTD., Suwon, Gyunggi-do (KR)

(21) Appl. No.: 13/750,866

(22) Filed: Jan. 25, 2013

(30) Foreign Application Priority Data
Nov. 5, 2012 (KR) 10-2012-0124491

(51) Int. Cl. G06F 3/0354

(52) U.S. Cl. CPC G06F 3/03545
USPC 345/179

(57) ABSTRACT

There are provided an electronic pen, and an electronic pen data input system and method using the same. The electronic pen includes: a triaxial accelerometer sensor sensing a change in acceleration based on triaxial coordinates of three fixed axes; and a controlling unit setting a reference point represented by the triaxial coordinates and generating acceleration information using the change in acceleration sensed by the triaxial accelerometer sensor due to movement of the electronic pen.

### CROSS-REFERENCE TO RELATED APPLICATIONS

This application claims the priority of Korean Patent Application No. 10-2012-0124491 filed on Nov. 5, 2012, in the Korean Intellectual Property Office, the disclosure of which is incorporated herein by reference.

### BACKGROUND OF THE INVENTION

1. Field of the Invention

The present invention relates to an electronic pen capable of performing a data input accurately using an accelerometer sensor that may maintain a reference axis regardless of a direction of the electronic pen, and an electronic pen data input system and method using the same.

2. Description of the Related Art

In accordance with the development of portable communications terminals, various portable communications terminals have been developed. These portable communications terminals such as cellular phones, tablet computers, and the like have tended to provide high degrees of processing performance together with portability. In addition, display modules of the portable communications terminals have been gradually developed so as to satisfy demands for high resolution and desired size.

As data input methods utilized in portable communications terminals, a method of directly receiving user data input through a touch screen, or the like, a method of receiving user data input using a predetermined electronic pen, and the like, have been used. In particular, the method of performing a data input using an electronic pen allows for more accurate data input as compared with the touch input method by hands.

However, an electronic pen according to the related art has a limitation in that it requires an excessive amount of sensors, and the like, for accuracy of input. In addition, the electronic pen according to the related art has a limitation in that it has a relatively large size, thereby decreasing portability of the portable communications terminal.

The following Related Art Documents (Patent Documents), related to electronic pen data input technology, do not overcome the above-mentioned limitations of the data input technology using the electronic pen.

### RELATED ART DOCUMENT

(Patent Document 1) Korean Patent No. 10-0408518
(Patent Document 2) Korean Patent No. 10-1127249

### SUMMARY OF THE INVENTION

An aspect of the present invention provides an electronic pen capable of performing a data input accurately by using an accelerometer sensor that may maintain a reference axis regardless of a direction of the electronic pen without touching a portable communications terminal, and an electronic pen data input system and method using the same.

According to an aspect of the present invention, there is provided an electronic pen including: a triaxial accelerometer sensor sensing a change in acceleration based on triaxial coordinates of three fixed axes; and a controlling unit setting a reference point represented by the triaxial coordinates and generating acceleration information using the change in acceleration sensed by the triaxial accelerometer sensor due to movement of the electronic pen.

The triaxial accelerometer sensor may include: a directing member allowing the triaxial accelerometer sensor to be constantly directed regardless of a gradient of the electronic pen; and a housing having the directing member and the triaxial accelerometer sensor housed therein.

The housing may have a spherical shape, and the directing member may be an object fixed to a portion of an inner surface of the housing and having a predetermined weight or more.

The triaxial accelerometer sensor may include a movable connection member electrically connecting the controlling unit and the triaxial accelerometer sensor, regardless of a gradient of the electronic pen.

The movable connection member may include a first distal end connected to the controlling unit; and a second distal end having a smoothly bent shape and contacting at least a portion of a conductive area of the housing of the triaxial accelerometer sensor.

According to another aspect of the present invention, there is provided an electronic pen data input system including: an electronic pen providing acceleration information corresponding to movement thereof using a triaxial accelerometer sensor based on fixed triaxial coordinates; and a portable communications terminal calculating movement information of the electronic pen using the acceleration information of the electronic pen and compensating for a noise input in the movement information to determine a handwriting data input.

The electronic pen may include: the triaxial accelerometer sensor sensing a change in acceleration based on the triaxial coordinates of three fixed axes; and a controlling unit setting a reference point represented by the triaxial coordinates and generating the acceleration information using the change in acceleration sensed by the triaxial accelerometer sensor due to the movement of the electronic pen.

The electronic pen may allow information regarding the reference point to be included in the acceleration information and provide the acceleration information to the portable communications terminal.

The portable communications terminal may integrate the acceleration information to calculate a movement path of the electronic pen and remove the noise input in the calculated movement path to determine the handwriting data input.

According to an aspect of the present invention, there is an electronic pen data input method performed by an electronic pen including a triaxial accelerometer sensor sensing a change in acceleration based on triaxial coordinates of three fixed axes and interworking with a portable communications terminal to generate a handwriting data input, the electronic pen data input method including: setting one point on the fixed triaxial coordinates as a reference point; detecting the change in acceleration on the fixed triaxial coordinates based on the reference point; and generating acceleration information including the change in acceleration and information regarding the reference point.

The generating of the acceleration information may include generating the acceleration information from the change in acceleration when a predetermined amount of pressure is sensed from the outside.

The electronic pen data input method may further include integrating the generated acceleration information to calculate movement information of the electronic pen.

The electronic pen data input method may further include compensating for noise information in the generated movement information to determine the handwriting data input.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a reference diagram illustrating an example of an electronic pen data input system according to the related art;

FIG. 2 is a reference diagram illustrating another example of an electronic pen data input system according to the related art;

FIG. 3 is a reference diagram illustrating an example of an electronic pen data input system according to an embodiment of the present invention;

FIG. 4 is a configuration diagram illustrating an example of an electronic pen according to an embodiment of the present invention;

FIG. 5 is a reference diagram illustrating a configuration of an electronic pen according to an embodiment of the present invention;

FIG. 6 is a reference diagram illustrating another configuration of an electronic pen according to an embodiment of the present invention;

FIGS. 7 and 8 are configuration diagrams illustrating examples of a triaxial accelerometer sensor of an electronic pen according to embodiments of the present invention;

FIG. 9 is a reference diagram illustrating an example of a movable connection member connecting a triaxial accelerometer sensor and a controlling unit in an electronic pen according to an embodiment of the present invention;

FIG. 10 is a configuration diagram illustrating an example of a portable communications terminal according to an embodiment of the present invention; and

FIGS. 11 and 12 are flowcharts illustrating an example of an electronic pen data input method according to embodiments of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of components may be exaggerated for clarity, and the same reference numerals will be used throughout to designate the same or like components.

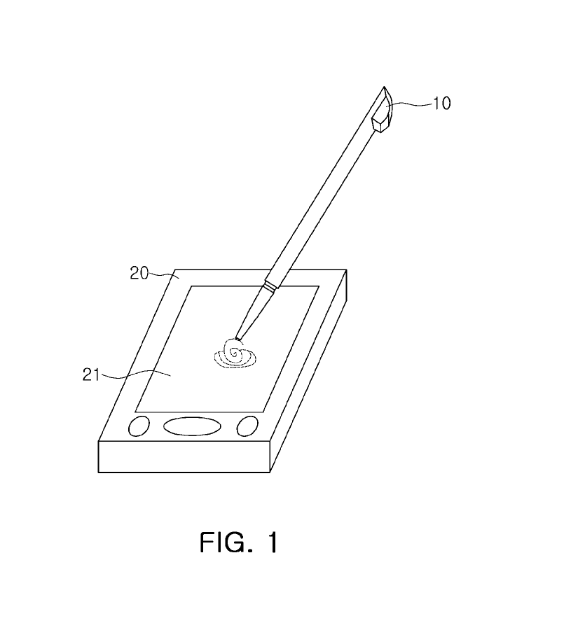

FIG. 1 is a reference diagram illustrating an example of an electronic pen data input system according to the related art.

The example of the electronic pen data input system shown in FIG. 1 relates to a scheme using a magnet.

In this scheme, the magnet may be attached to a distal end of an electronic pen 10 to form a magnetic field. Therefore, in the case in which the electronic pen touches a surface of a capacitive touch panel 21 of a portable communications terminal 20, an electrical field is changed due to the magnetic field and a change amount is detected to perform a data input.

However, in the case of this scheme, since the magnetic field is expanded in a predetermined range, it is difficult to accurately determine the input, such that an erroneous data recognition rate is significantly high. In addition, the input should only be performed on the touch panel 21 of the portable communications terminal.

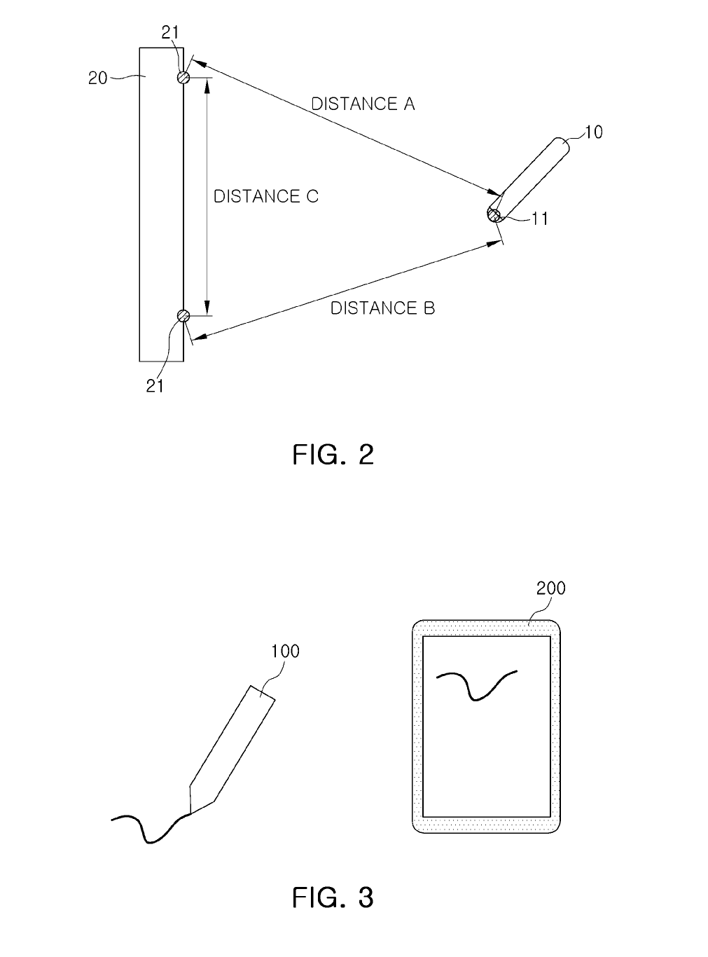

FIG. 2 is a reference diagram illustrating another example of an electronic pen data input system according to the related art. Another example of the electronic pen data input system shown in FIG. 2 relates to a scheme using an ultrasonic sensor.

That is, in this scheme, an ultrasonic transmitting sensor 11 is attached to a distal end of an electronic pen 10, and two ultrasonic receiving sensors 21 are provided in a portable communications terminal 20 to determine a position of the electronic pen through triangulation using distances (distances A to C) between the respective ultrasonic sensors.

This scheme has an advantage in that a data input may be performed without touching the portable communications terminal 20, but has a limitation in that a plurality of ultrasonic sensors 11 and 21 are required and at least two ultrasonic sensors are also required in the portable communications terminal 20. Therefore, due to the above-mentioned limitation, it is difficult to apply this scheme to various portable communications terminals.

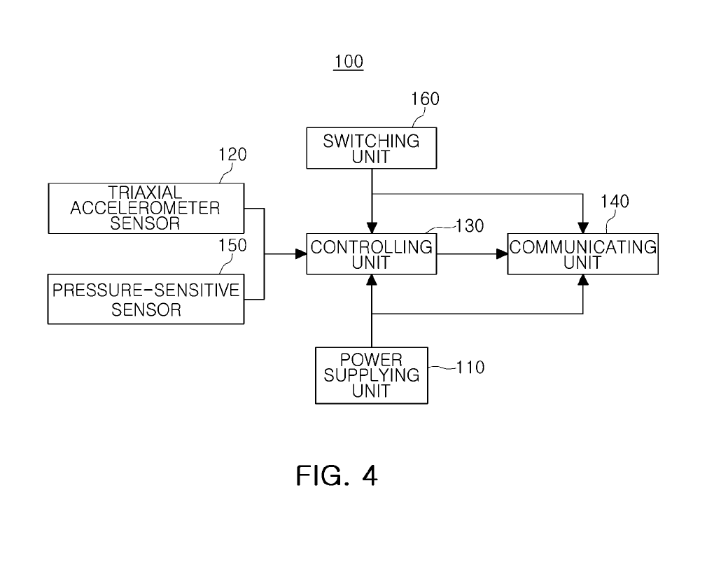

Hereinafter, an electronic pen data input system according to an embodiment of the present invention and an electronic pen data input method according to an embodiment of the present invention will be described in detail with reference to FIGS. 3 through 12.

FIG. 3 is a reference diagram illustrating an example of an electronic pen data input system according to an embodiment of the present invention.

As shown in FIG. 3, an electronic pen data input system according to the embodiment of the present invention may include an electronic pen 100 and a portable communications terminal 200.

Although the electronic pen 100 and the portable communications terminal 200 form a communications environment therebetween by a wireless communications method in this embodiment of FIG. 3, the electronic pen 100 and the portable communications terminal 200 may communicate with each other by a wired communications method according to embodiments of the present invention. For example, it is obvious that a scheme of directly connecting a flexible cable (not shown) provided at a distal end of the electronic pen 100 to the portable communications terminal 200 to perform wired communications may be implemented.

The electronic pen 100 may provide acceleration information corresponding to a movement thereof using a triaxial accelerometer sensor based on fixed triaxial coordinates.

The portable communications terminal 200 may calculate movement information of the electronic pen 100 using the acceleration information of the electronic pen 100 and compensate for noise in the calculated movement information to determine a handwriting data input.

As shown in FIG. 3, according to the embodiment of the present invention, the electronic pen 100 may perform the data input using any plane. That is, according to the embodiment of the present invention, the data input may be performed on any plane in addition to a touch panel of the portable communications terminal 200. The reason is that since the electronic pen 100 according to the embodiment of the present invention includes the accelerometer sensor, a movement path thereof may be calculated using the accelerometer sensor.

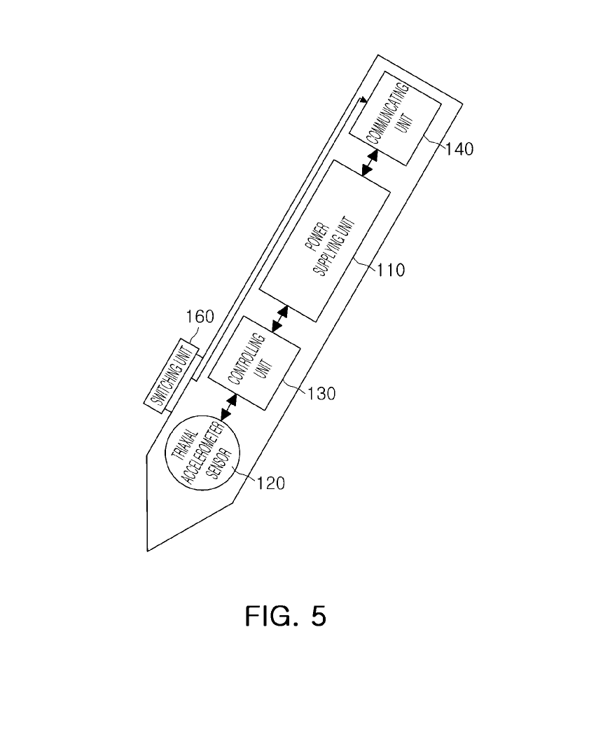

The electronic pen 100 and the portable communications terminal 200 will be described below in more detail with reference to FIGS. 4 through 11.

FIG. 4 is a configuration diagram illustrating an example of the electronic pen according to an embodiment of the present invention.

Referring to FIG. 4, the electronic pen 100 may include a power supplying unit 110, a triaxial accelerometer sensor 120, a controlling unit 130, and a communicating unit 140. In the embodiment of the present invention, the electronic pen 100 may further include at least one of a pressure-sensitive sensor 150 and a switching unit 160.

The power supplying unit 110 may supply power to components of the electronic pen 100.

The triaxial accelerometer sensor 120 may sense a change in acceleration based on triaxial coordinates of the electronic pen 100 based on the three fixed axes. That is, in the embodiment of the present invention, the triaxial accelerometer sensor 120 may maintain a triaxial coordinate system regardless of a current gradient of the electronic pen 100. For example, regardless of whether the electronic pen 100 is perpendicular to a plane or is inclined at 45 degrees, the triaxial accelerometer sensor 120 may maintain a fixed triaxial coordinate system.

Here, the fixed triaxial coordinate system may be present on a Z axis (height axis) parallel to a direction of gravitational attraction and a plane perpendicular to the Z axis and be represented by an X axis (horizontal axis) and a Y axis (vertical axis) that are perpendicular to each other.

The triaxial accelerometer sensor 120 may provide data on the sensed change in acceleration on the triaxial coordinates to the controlling unit 130.

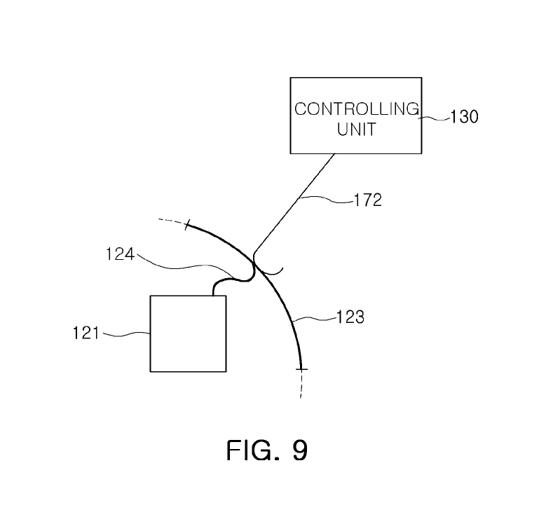

The triaxial accelerometer sensor 120 will be described below in more detail with reference to FIGS. 7 and 8.

The controlling unit 130 may control other components of the electronic pen 100.

In the embodiment of the present invention, the controlling unit 130 may generate acceleration information using the data on the change in acceleration sensed by the triaxial accelerometer sensor 120 due to movement of the electronic pen 100.

In the embodiment of the present invention, the controlling unit 130 may set information regarding a reference point. The reference point means a specific point represented by the triaxial coordinates. That is, since the data sensed by the accelerometer sensor 120 is an amount of change in acceleration, a specific reference point is required in order to calculate a movement line of the electronic pen 100 from the acceleration. Therefore, when a specific point is set as the reference point, the controlling unit 130 may set a triaxial point corresponding to the set reference point as information regarding the reference point.

In the embodiment of the present invention, the controlling unit 130 may allow the information regarding the reference point to be included in the acceleration information and provide the acceleration information to the portable communications terminal 200. In the embodiment of the present invention, the acceleration information may include the data on the change in acceleration on the triaxial coordinates sensed by the triaxial accelerometer sensor 120 and the information regarding the reference point.

In the embodiment of the present invention, the controlling unit 130 may calculate the handwriting data input by the movement of the electronic pen 100 using the data on the change in acceleration sensed by the triaxial accelerometer sensor 120. That is, in the present embodiment, a process of calculating the handwriting data input of the electronic pen 100 from the acceleration information may be performed by the electronic pen 100 itself. However, according to another embodiment of the present invention, the process of calculating the handwriting data input of the electronic pen 100 from the acceleration information may also be performed by the portable communications terminal 200.

More specifically, the controlling unit 130 may calculate information regarding a movement distance of the electronic pen (hereinafter, referred to as “movement information”) from the acceleration information and compensate for noise in the calculated movement information to calculate handwriting data input information by the electronic pen 100.

Here, the acceleration information may be integrated to thereby be calculated as speed information. This may be calculated by the following Equation 1.

$$s = {v}_{0} t + \frac{1}{2} {at}^{2} \qquad [ Equation 1 ]$$

where S indicates a movement distance, V₀ indicates an initial speed, a indicates acceleration, and t indicates time. The above Equation 1 may be integrated to calculate a relationship between the acceleration and the speed and calculate the movement distance from the acceleration information using the relationship between the acceleration and the speed.

In general, in the case of performing a data input using an electronic pen, the electronic pen may be moved for movement between characters to be written, in addition to movement for a handwriting data input. According to the embodiment of the present invention, the movement of the electronic pen between the characters may be judged as a noise input, such that compensation for deleting the noise input may be performed. For example, in the case in which a height axis (Z axis) is equal to or greater than a preset numerical value, the corresponding movement information may be determined to be noise.

The communicating unit 140 may communicate with the portable communications terminal 200.

In the embodiment of the present invention, the communicating unit 140 may form or maintain a communications session with the portable communications terminal 200 in a wireless communication scheme.

In another embodiment of the present invention, the communicating unit 140 may be connected to the portable communications terminal 200 in a wired communication scheme. In this case, the communicating unit 140 may be formed integrally with the power supplying unit 110 to receive power from the portable communications terminal 200 through a wired line.

The pressure-sensitive sensor 150, which is a sensor sensing an amount of pressure provided from the outside, may be provided at one end of the electronic pen 100. For example, the pressure-sensitive sensor 150 may be protruded at a distal end of the electronic pen 100 and sense pressure equal to or higher than a predetermined value in the case of performing the handwriting data input using the electronic pen 100. The controlling unit 130 may process the pressure provided from the outside as a valid input only in the case in which pressure of a threshold value or more is sensed by the pressure-sensitive sensor 150. For example, the controlling unit 130 may only accept acceleration data detected while the pressure of the threshold value or more is sensed by the pressure-sensitive sensor 150 as valid data to generate acceleration information.

The switching unit 160 may sense an external pressing input. For example, the switching unit 160 may be provided in any position of a body of the electronic pen 100 to sense the pressing input by a user's finger. The controlling unit 130 may process the external pressing input as a valid input only in the case in which the pressing input is sensed by the switching unit 160. For example, the controlling unit 130 may only accept acceleration data detected while the pressing input is sensed by the switching unit 160 as valid data to generate acceleration information.

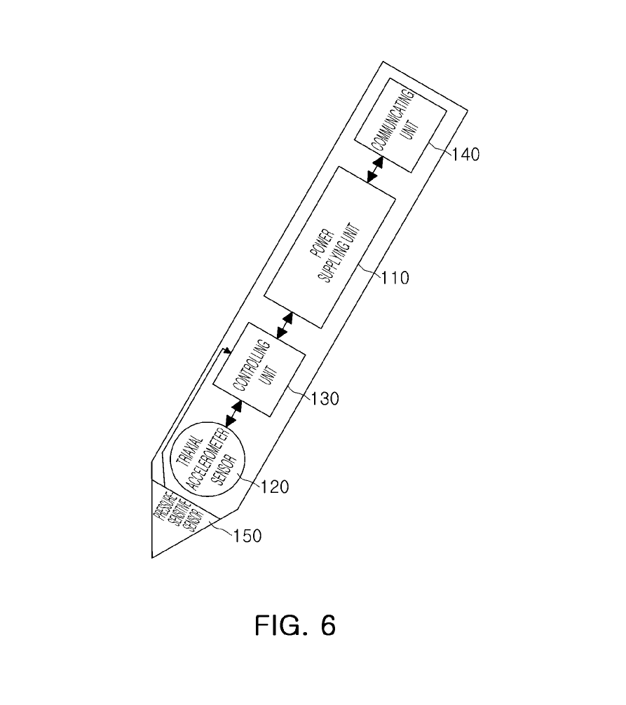

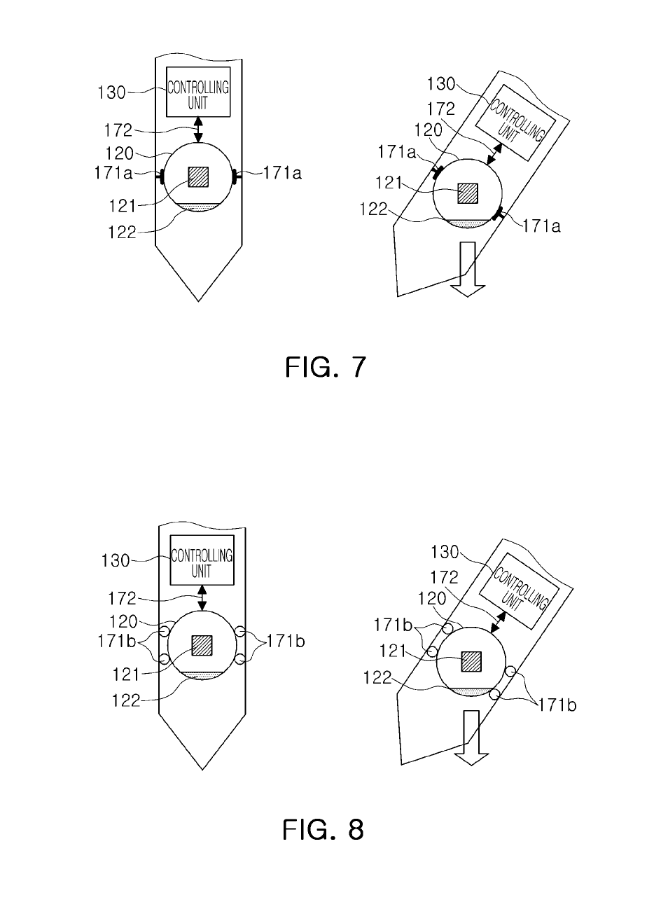

FIGS. 5 and 6 are reference diagrams illustrating one configuration and another configuration of an electronic pen according to the embodiment of the present invention.

FIG. 5 shows the electronic pen 100 including the switching unit 160; and FIG. 6 shows the electronic pen 100 including the pressure-sensitive sensor 150.

In one example of FIG. 5, the pressing input of the switching unit 160 is connected to the communicating unit 140. In this configuration, the acceleration information, or the like, may be transmitted to the portable communications terminal 200 only while the pressing input is present. However, as described above, the pressing input of the switching unit 160 may be provided to the controlling unit 130.

In another example of FIG. 6, the pressure-sensitive sensor 150 is provided at a distal end of the electronic pen 100. The pressure-sensitive sensor 150 may provide a sensed pressure value to the controlling unit 130, and the controlling unit 150 may determine the pressure value as a valid input only in the case in which the pressure value provided by the pressure-sensitive sensor 150 is equal to or higher than a predetermined value, as described above.

FIGS. 7 and 8 are configuration diagrams illustrating examples of a triaxial accelerometer sensor of an electronic pen according to an embodiment of the present invention.

Referring to FIGS. 7 and 8, the triaxial accelerometer sensor 120 may include an accelerometer sensor module 121, a directing member 122, and a housing 123.

The accelerometer sensor module 121 may perform triaxial acceleration sensing. The accelerometer sensor module 121 may be fixed to an internal space of the housing 123.

The directing member 122 may allow the triaxial accelerometer sensor 120, more specifically, the accelerometer sensor module 121, to be constantly directed regardless of a gradient of the electronic pen 100.

In the embodiment of the present invention, the directing member 122 may be an object fixed to a portion of an inner surface of the housing 123 and having a predetermined weight or more. That is, the directing member 122 may have sufficient weight as compared with total weight of the triaxial accelerometer sensor 120 to maintain a direction of gravitational attraction regardless of movement of the electronic pen 100.

The housing 123 may have the directing member 122 and the accelerometer sensor module 121 housed therein.

In the embodiment of the present invention, the housing 123 may have a hollow spherical shape to fix the directing member 122 and the accelerometer sensor module 121 thereinto.

The housing 123 may be fixed by an internal fixing member 171 of the electronic pen 100. However, the housing 123 and the internal fixing member 171 are not firmly fixed to each other. Therefore, the housing 123 may rotate in a specific direction, that is, in a direction in which the directing member 122 is directed toward the ground. To this end, FIG. 7 shows an internal fixing member 171a including a curved inner portion having a concave shape, and FIG. 8 shows two pairs of circular internal fixing members 171b fixed to an inner portion of the electronic pen 100.

However, since the internal fixing members 171a and 171b shown in FIGS. 7 and 8 are only examples, the internal fixing members 171a and 171b according to the embodiment of the present invention are not necessarily limited thereto. That is, the internal fixing members 171a and 171b may fix the housing 123 at a predetermined level while allowing the housing 123 to be rotated.

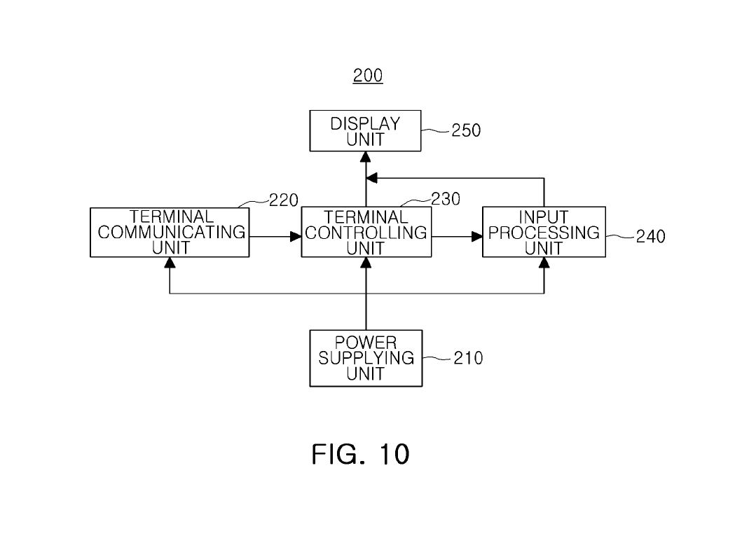

A movable connection member 172 may electrically connect the controlling unit 130 and the triaxial accelerometer sensor 120. The movable connection member 172 will be described with reference to FIG. 9.

FIG. 9 is a reference diagram illustrating an example of a movable connection member connecting a triaxial accelerometer sensor and a controlling unit in an electronic pen according to an embodiment of the present invention.

The movable connection member 172 may electrically connect the controlling unit 130 and the triaxial accelerometer sensor 120, regardless of the gradient of the electronic pen 100.

Referring to FIG. 9, the movable connection member 172 may have a first distal end connected to the controlling unit 130 and a second distal end contacting at least a portion of a conductive area of the housing 123 of the triaxial accelerometer sensor 120. Here, the second distal end may have a smoothly bent shape, and the bent outer surface may contact at least a portion of the conductive area of the housing 123 to thereby make an electrical connection.

To this end, the inner portion of the triaxial accelerometer sensor 120 may be further provided with a conductive connection member 124 connecting the conductive area of the housing 123 and the accelerometer sensor module 121.

In addition, since the movable connection member 172 shown in FIG. 9 is only an example, the movable connection member 172 according to the embodiment of the present invention is not necessarily limited thereto. For example, the movable connection member 172 may also be configured as a flexible cable electrically connecting the accelerometer sensor module 121 and the controlling unit 130.

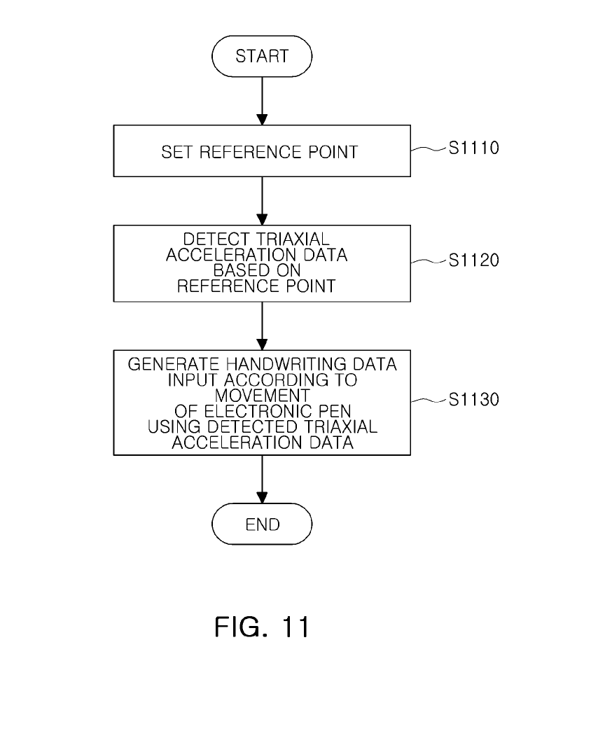

FIG. 10 is a configuration diagram illustrating an example of a portable communications terminal according to an embodiment of the present invention.

Referring to FIG. 10, the portable communications terminal 200 may include a power supplying unit 210, a terminal communicating unit 220, a terminal controlling unit 230, an input processing unit 240, and a display unit 250.

The power supplying unit 210 may supply power to components of the portable communications terminal 200.

The terminal communicating unit 220 may communicate with the electronic pen 100.

In the embodiment of the present invention, the terminal communicating unit 220 may form or maintain a communications session with the electronic pen 100 in a wireless communication scheme.

In another embodiment of the present invention, the terminal communicating unit 220 may be connected to the electronic pen 100 in a wired communication scheme. In this case, the terminal communicating unit 220 may be formed integrally with the power supplying unit 210 to provide the power to the electronic pen 100 through a wired line.

The terminal controlling unit 230 may control other components of the portable communications terminal 200.

In the embodiment of the present invention, when the terminal controlling unit 230 receives acceleration information from the electronic pen 100, it may provide the acceleration information to the input processing unit 240.

The input processing unit 240 may determine the handwriting data input of the electronic pen 100 using the acceleration information.

In the embodiment of the present invention, the input processing unit 240 may calculate a movement path of the electronic pen 100 from information regarding a reference point and acceleration data included in the acceleration information and remove the noise input in the calculated movement path to determine the handwriting data input of the electronic pen 100. Since this corresponds to the above description with reference to Equation 1, a detailed description thereof will be omitted.

In the embodiment of the present invention, the input processing unit 240 may allow a specific position of the display unit 250 of the portable communications terminal 200 to correspond to the reference point received from the electronic pen 100, thereby determining the handwriting data input.

In the embodiment of the present invention, the input processing unit 240 may determine a plane (input plane) on which the electronic pen 100 performs the handwriting data input and match the input plane to the display unit 250 to determine a display ratio of the handwriting data input using a ratio between the input plane and the display unit 250.

For example, the input processing unit 240 may receive the reference point and a ratio determining point from the electronic pen 100. Here, the ratio determining point may be a specific point for determining the plane (input plane) on which the electronic pen 100 performs the handwriting data input. The ratio determining point may include at least one of a width determining point and a length determining point. The input processing unit 240 may allow a relationship between the reference point and the ratio determining point to correspond to a portion of a size of the display unit 250 of the portable communications terminal 200, thereby determining an output ratio of the handwriting data input.

The display unit 250 may display the handwritten data input of the electronic pen 100 by the input processing unit 240.

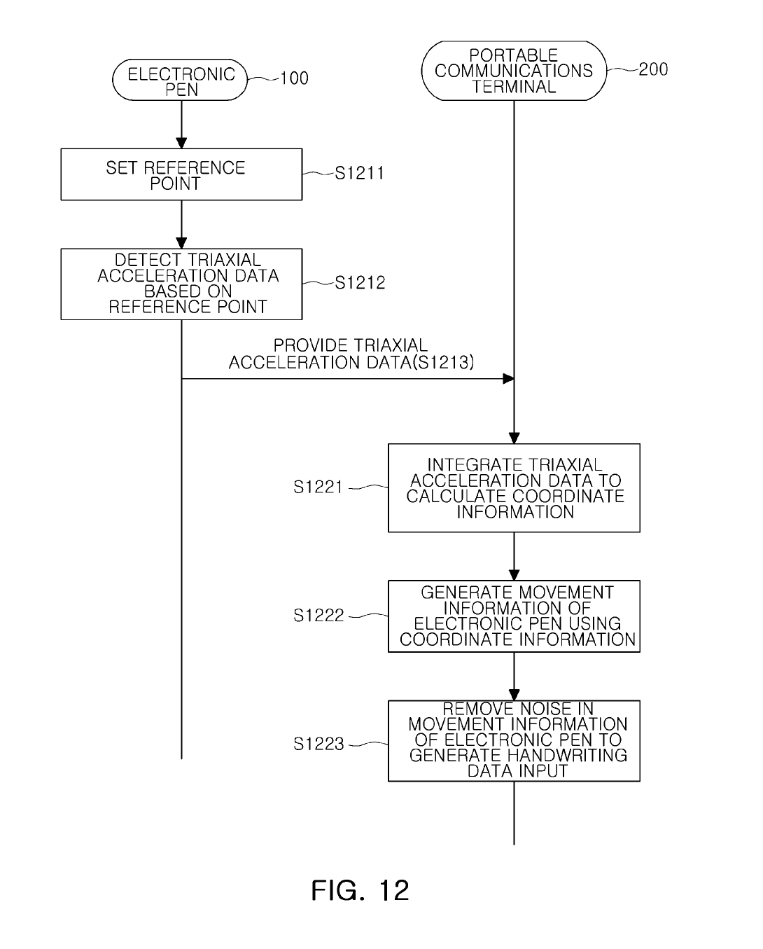

FIGS. 11 and 12 are flowcharts illustrating an example of an electronic pen data input method according to an embodiment of the present invention.

Hereinafter, an electronic pen data input method according to the embodiment of the present invention will be described with reference to FIGS. 11 and 12. However, since the electronic pen data input method according to the embodiment of the present invention is performed by the electronic pen 100 and the portable communications terminal 200 described above with reference to FIGS. 4 through 10, overlapping descriptions will be omitted. However, those skilled in the art will clearly understand the electronic pen data input method according to the embodiment of the present invention from the above-mentioned descriptions.

FIG. 11 is a flowchart illustrating an example of an electronic pen data input method according to an embodiment of the present invention.

Referring to FIG. 11, the electronic pen data input method includes setting one point on fixed triaxial coordinates as a reference point (S1110), detecting triaxial acceleration data based on the reference point (S1120), and generating a handwriting data input according to movement of the electronic pen 100 using the detected triaxial acceleration data (S1130).

Here, operations S1110 and S1120 may be performed by the electronic pen 100. However, operation S1130 may be performed by the electronic pen 100 itself or be performed by the portable communications terminal 200.

FIG. 12 is a flowchart illustrating a specific example of an electronic pen data input method.

Referring to FIG. 12, the electronic pen 100 may set one point on fixed triaxial coordinates as a reference point (S1211) and detect triaxial acceleration data based on the reference point (S1212).

The electronic pen 100 may provide the triaxial acceleration data to the portable communications terminal (S1213).

The portable communications terminal 200 may integrate the triaxial acceleration data to calculate coordinate information (S1221) and generate movement information of the electronic pen 100 using the calculated coordinate information (S1222).

The portable communications terminal 200 may remove noise in the movement information of the electronic pen 100 to generate a handwriting data input (S1223).

As set forth above, according to embodiments of the present invention, an accelerometer sensor that may maintain a reference axis regardless of a direction of an electronic pen is used, whereby a data input may be more accurately performed without touching a portable communications terminal.

While the present invention has been shown and described in connection with the embodiments, it will be apparent to those skilled in the art that modifications and variations can be made without departing from the spirit and scope of the invention as defined by the appended claims.

What is claimed is:

1. An electronic pen comprising:
a triaxial accelerometer sensor sensing a change in acceleration based on triaxial coordinates of three fixed axes; and
a controlling unit setting a reference point represented by the triaxial coordinates and generating acceleration information using the change in acceleration sensed by the triaxial accelerometer sensor due to movement of the electronic pen.

2. The electronic pen of claim 1, wherein the triaxial accelerometer sensor includes:
a directing member allowing the triaxial accelerometer sensor to be constantly directed regardless of a gradient of the electronic pen; and
a housing having the directing member and the triaxial accelerometer sensor housed therein.

3. The electronic pen of claim 2, wherein the housing has a spherical shape, and
the directing member is an object fixed to a portion of an inner surface of the housing and having a predetermined weight or more.

4. The electronic pen of claim 2, wherein the triaxial accelerometer sensor includes a movable connection member electrically connecting the controlling unit and the triaxial accelerometer sensor, regardless of a gradient of the electronic pen.

5. The electronic pen of claim 4, wherein the movable connection member includes:
a first distal end connected to the controlling unit; and
a second distal end having a smoothly bent shape and contacting at least a portion of a conductive area of the housing of the triaxial accelerometer sensor.

6. An electronic pen data input system comprising:
an electronic pen providing acceleration information corresponding to movement thereof using a triaxial accelerometer sensor based on fixed triaxial coordinates; and
a portable communications terminal calculating movement information of the electronic pen using the acceleration information of the electronic pen and compensating for a noise input in the movement information to determine a handwriting data input.

7. The electronic pen data input system of claim 6, wherein the electronic pen includes:
the triaxial accelerometer sensor sensing a change in acceleration based on the triaxial coordinates of three fixed axes; and
a controlling unit setting a reference point represented by the triaxial coordinates and generating the acceleration information using the change in acceleration sensed by the triaxial accelerometer sensor due to the movement of the electronic pen.

8. The electronic pen data input system of claim 6, wherein the electronic pen allows information regarding the reference point to be included in the acceleration information and provides the acceleration information to the portable communications terminal.

9. The electronic pen data input system of claim 6, wherein the portable communications terminal integrates the acceleration information to calculate a movement path of the electronic pen and removes the noise input in the calculated movement path to determine the handwriting data input.

10. An electronic pen data input method performed by an electronic pen including a triaxial accelerometer sensor sensing a change in acceleration based on triaxial coordinates of three fixed axes and interworking with a portable communications terminal to generate a handwriting data input, the electronic pen data input method comprising:
setting one point on the fixed triaxial coordinates as a reference point;
detecting the change in acceleration on the fixed triaxial coordinates based on the reference point; and
generating acceleration information including the change in acceleration and information regarding the reference point.

11. The electronic pen data input method of claim 10, wherein the generating of the acceleration information includes generating the acceleration information from the change in acceleration when a predetermined amount of pressure is sensed from the outside.

12. The electronic pen data input method of claim 10, further comprising integrating the generated acceleration information to calculate movement information of the electronic pen.

13. The electronic pen data input method of claim 12, further comprising compensating for noise information in the generated movement information to determine the handwriting data input.
